(19) United States
(12) Patent Application Publication
(10) Pub. No.: US 2008/0141772 A1
(43) Pub. Date: Jun. 19, 2008

(54) SYSTEM AND METHOD FOR DISTANCE FUNCTIONALITY

(75) Inventors: Markus Kahari, Helsinki (FI); David J. Murphy, Helsinki (FI); Yka Huhtala, Helsinki (FI)

Correspondence Address: MORGAN & FINNEGAN, L.L.P., 3 WORLD FINANCIAL CENTER, NEW YORK, NY, 10281-2101, US

(73) Assignee: Nokia Corporation, Espoo (FI)

(21) Appl. No.: 11/610,146

(22) Filed: Dec. 13, 2006

(51) Int. Cl. G01C 3/00

(52) U.S. Cl. 73/432.1

(57) ABSTRACT

Systems and methods applicable, for example, in distance functionality. Distances might, for instance, be ascertained. One or more heights, one or more optical values, information corresponding to orientation, and/or one or more values corresponding to captured images might, for example, be employed. Ascertained distances might, for example, be updated. An area captured by a device of a first user might, for instance, be recognized as captured by a device of a second user. Such recognition might, for example involve the use of one or more distances between the two users.

### FIELD OF INVENTION

This invention relates to systems and methods for distance functionality.

### BACKGROUND INFORMATION

In recent times, there has been an increase in users adopting their devices (e.g., wireless nodes and/or other computers) for differing purposes.

For example, many users have eagerly adopted the use of their devices for consumption of audio and video in place of other ways of consuming audio and video. As another example, many users have eagerly adopted the use of their devices for communication in place of other ways of communicating. As yet another example, many users have eagerly adopted the use of their devices for gaming in place of other ways of gaming.

Accordingly, there may be interest in technologies that provide further uses for such devices.

### SUMMARY OF THE INVENTION

According to embodiments of the present invention, there are provided systems and methods applicable, for example, in distance functionality.

Distances might, in various embodiments, be ascertained. One or more heights, one or more optical values, information corresponding to orientation, and/or one or more values corresponding to captured images might, in various embodiments, be employed. In various embodiments, ascertained distances might be updated.

An area captured by a device of a first user might, in various embodiments, be recognized as captured by a device of a second user. In various embodiments, such recognition might involve the use of one or more distances between the two users.

### BRIEF DESCRIPTION OF THE DRAWINGS

FIG. 1 shows exemplary steps involved in distance ascertainment operations according to various embodiments of the present invention.

FIG. 2 shows an exemplary depiction according to various embodiments of the present invention.

FIG. 3 shows a further exemplary depiction according to various embodiments of the present invention.

FIG. 4 shows exemplary steps involved in view operations according to various embodiments of the present invention.

FIG. 5 shows further exemplary steps involved in view operations according to various embodiments of the present invention.

FIG. 6 shows an exemplary computer.

FIG. 7 shows a further exemplary computer.

### DETAILED DESCRIPTION OF THE INVENTION

### General Operation

According to embodiments of the present invention, there are provided systems and methods applicable, for example, in distance functionality.

Distances (e.g., between users) might, in various embodiments, be ascertained. In various embodiments, a first user might aim a device at a second user. One or more heights of the first user, one or more optical values of the device, information corresponding to the orientation of the device (e.g., received from one or more orientation sensors such as, for instance, accelerometers and/or magnetometers), and/or one or more values corresponding to captured images might be employed in ascertaining the distance between the first user and the second user. Such a height might, in various embodiments, be provided by the first user (e.g., via a Graphical User Interface (GUI) and/or other interface). One or more body position indications, altitudes, and/or heights of the second user might, in various embodiments, be employed in ascertaining the distance between the first user and the second user. Moreover, in various embodiments, the ascertained distance might be updated. Such updating might, in various embodiments, involve the use of received data (e.g., orientation sensor output).

It is additionally noted that, in various embodiments, an area captured by a device of a first user might be recognized as captured by a device of a second user. Such recognition might, in various embodiments, involve the use of one or more distances between the two users (e.g., ascertained as discussed above) and/or one or more device orientation values. The area might, in various embodiments, be user selected (e.g., via a GUI and/or other interface) and/or selected by a device. In various embodiments, provided for might be user manipulation of the area (e.g., object depiction modification and/or virtual object placement), information presentation corresponding to the area, and/or game play corresponding to the area.

Various aspects of the present invention will now be discussed in greater detail.

### Distance Ascertainment Operations

According to various embodiments of the present invention, one or more distances may be ascertained. Such distances might, for instance, include distances between users. Such functionality may be implemented in a number of ways.

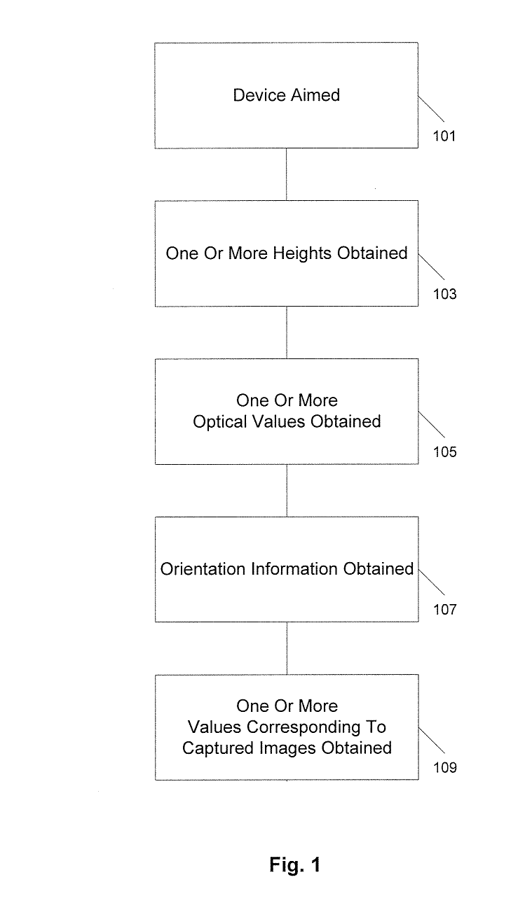

With respect to FIG. 1 it is noted that, for example, in the case where the distance between two users is to be calculated, a first of the users might aim a device at a second of the two users (step 101). It is noted that, in various embodiments, devices discussed herein might be wireless nodes and/or other computers. It is further noted that, in various embodiments, devices discussed herein might be image capture devices, include image capture devices, and/or be in communication with image capture devices. Such communication might, for instance, involve the use of, Firewire (e.g., IEEE 1394 and/or IEEE 1394b Firewire), Universal Serial Bus (USB), Bluetooth (e.g., IEEE 802.15.1 and/or UWB Bluetooth), WiFi (e.g., IEEE 802.11b, IEEE 802.11g, and/or IEEE 802.11n WiFi), and/or I2C (Inter-Integrated Circuit). It is additionally noted that image capture devices discussed herein might, for instance employ Complementary Metal Oxide Semiconductor (CMOS) and/or Charge Coupled Device (CCD) hardware).

The first user might, for example, so aim the device in response to receiving instruction to do so, and/or might provide indication that distance calculation is desired. The first user might, for instance, be instructed to hold the device at eye level and/or at a particular angle during aiming. Such receipt of instruction and/or provision of indication might, for instance, be via a GUI and/or other interface (e.g., provided by her device. The device of the first user might, for instance, capture one or more images of the second user.

Obtained might, for example, be one or more heights of the first user (step 103). Such functionality might be implemented in a number of ways. For example, the user might enter her height via a GUI and/or other interface (e.g., one provided by her device). As another example, the height of the first user might be obtained from a remote and/or accessible store (e.g., a customer information database). Communication with such a store might be implemented in a number of ways. For instance, Bluetooth (e.g., IEEE 802.15.1 and/or UWB Bluetooth), WiFi (e.g., IEEE 802.11b, IEEE 802.11g, and/or IEEE 802.11n WiFi), Worldwide Interoperability for Microwave Access (WiMAX) (e.g., IEEE 802.16e WiMAX), Local Area Network (LAN), Wide Area Network (WAN) (e.g., the Internet), Web-based Distributed Authoring and Versioning (WebDAV), File Transfer Protocol (FTP), Apple Filing Protocol (AFP), Server Message Block (SMB), Really Simple Syndication (RSS), General Packet Radio Service (GPRS), Universal Mobile Telecommunications Service (UMTS), Global System for Mobile Communications (GSM), Simple Object Access Protocol (SOAP), Java Messaging Service (JMS), Remote Method Invocation (RMI), Remote Procedure Call (RPC), sockets, and/or pipes might be employed.

As yet another example, the height of the first user might be deduced. For instance, output of altitude determination hardware (e.g., barometer hardware) might be employed in conjunction with information (e.g., received from a remote and/or accessible store such as, for instance, a geographic information database) indicating the altitude of the location of the first user. Communication with the remote and/or accessible store might, for instance, be implemented in a manner analogous to that discussed above.

Output of the altitude determination hardware might, for instance, be read subsequent to the first user, perhaps via a GUI and/or other interface of her device, being instructed to hold her device at a particular level (e.g., at the level of her eyes and/or her head). The altitude of the location of the first user might, for example, be subtracted from an altitude indicated by the altitude determination hardware might so as to yield a deduction of the height of the user. Perhaps in a manner analogous to that discussed above, the altitude determination hardware might, for instance, be included in and/or be in communication with the device of the first user.

The height of the first user might, for instance, be employed in deducing the distance between the user's eyes and the ground. Such functionality might be implemented in a number of ways. For example, the distance between the first user's eyes and the ground might be considered to be a certain percentage of her total height. As another example, the first user's height, minus a certain offset, might be taken to be the distance between the first user's eyes and the ground. Such percentages and/or offsets might, for example, be based on human physiology.

As another example, such an offset might be determined via image analysis of one or more images captured by one or more image capture devices facing the first user. Such captured images might, for instance, depict one or both eyes of the first user and one or more portions of the first user's head (e.g., the top of the first user's head). Such image analysis might, for instance, involve determining one or more distances between one or both eyes of the first user and one or more portions of the first user's head (e.g., the top of the first user's head). It is additionally noted that, in various embodiments, the first user's height might be taken to be the distance between her eyes and the ground (e.g., a percentage of one hundred and/or an offset of zero might be employed).

As another example, obtained might be one or more optical values (e.g., an aperture angle) of the first user's device (step 105). Such a value might, for instance, be obtained from an accessible store (e.g., in a manner analogous to that discussed above), be obtained from the first user (e.g., in a manner analogous to that discussed above), and/or be received via communication with hardware (e.g., via communication between the device of the first user and an image capture device included in and/or in communication with the first user's device). It is noted that, in various embodiments, such a value might be zoom setting dependent.

As yet another example, obtained might be information corresponding to the orientation of the first user's device (step 107). Such orientation information might, for instance, be received via communication with orientation sensor hardware (e.g., one or more accelerometers and/or magnetometers). Perhaps in a manner analogous to that discussed above, such orientation sensor hardware might, for instance, be included in and/or be in communication with the device of the first user. Included in and/or derived from the obtained information corresponding to the orientation of the first user's device might, in various embodiments, be an angle between an imaginary vertical line running the height of the first user and an imaginary line extending from the device of the first user (e.g., extending from a lens of a device of the first user).

As a further example, obtained might be one or more values corresponding to captured images of the second user (e.g., images captured as discussed above) (step 109). Such functionality might be implemented in a number of ways.

For example, a total image size value (e.g., the total size of the image in the vertical direction) and a beneath-horizon image size value (e.g., the, perhaps vertical, portion of the image extending below the feet of the second user) might be determined. Such values might, for instance, be expressed in numbers of pixels.

As another example, one or more sizes of the second user as depicted by one or more of the images might be determined. Such sizes might, for example, include the height of the second user and/or one or more sizes of one or more portions of the second user (e.g., the size of the head of the second user). Such sizes might, for example, be specified in terms of numbers of pixels. Edge recognition, pattern recognition, image segmentation, and/or operations employed in motion estimation (e.g., motion estimation for video encoding) might, for instance, be performed. Such operations might, for example, serve to identify portions of the images that depict the second user and/or extract from the images the those portions that depict the second user.

As an additional example, obtained might be the altitude of the second user. Such an altitude might, perhaps in a manner analogous to that discussed above, be obtained via the output of altitude determination hardware (e.g., of the sort discussed above). Perhaps in a manner analogous to that discussed above, the altitude determination hardware might, for instance, be included in and/or be in communication with a device of the second user. As yet another example, obtained might be an indication of the body position of the second user (e.g., sitting or standing) and/or the height of the second user.

One or more distance calculations might, for instance, be performed with respect to some or all of that which is discussed above. For example, such calculations might involve one or more heights of the first user, one or more optical values of the device of the first user, one or more orientations of the device of the first user, one or more values corresponding to captured images of the second user, one or more altitudes of the second user, one or more body position indications corresponding to the second user, and/or one or more heights of the second user.

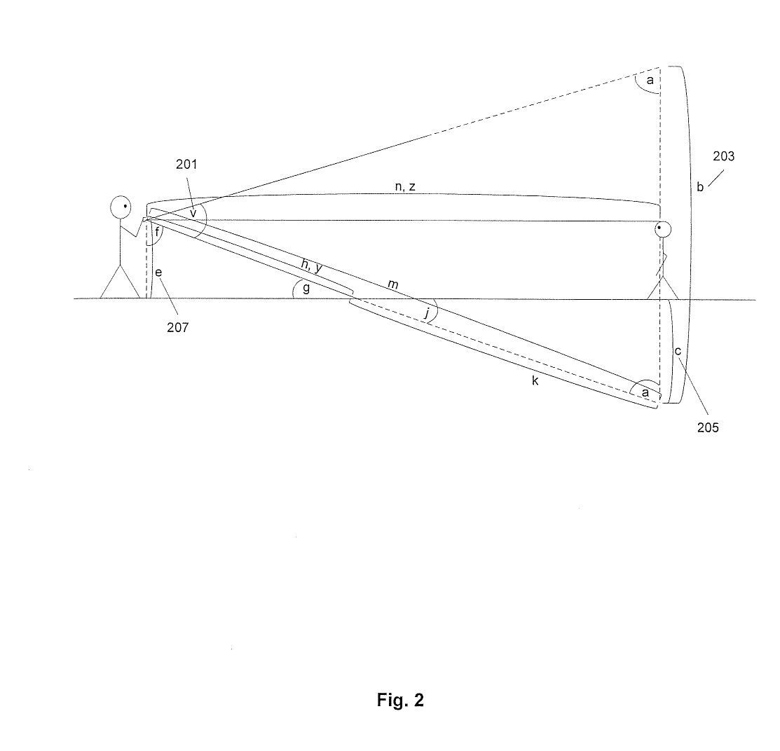

With respect to FIG. 2, an exemplary distance calculation wherein the angle between an imaginary vertical line running the height of an aiming user and an imaginary line extending from the device of the aiming user (e.g., from a lens of the device) is 90° will now be discussed. Is it noted that, in various embodiments, an aiming user might be instructed (e.g., via a GUI and/or other interface) to hold her device at particular angle (e.g., such that there is 90° between an imaginary vertical line running the height of the user and an imaginary line extending from a lens of the device).

For an aperture angle of v (201), angle a may be calculated as:

$$a = \frac{180 ° - v}{2} .$$

Suppose that the total image size in the vertical direction is b pixels (203), and the beneath-horizon image size value in the vertical direction is c pixels (205). Further suppose that the distance between the aiming user's eyes and the ground is found to be e meters (207).

Angle f may be calculated as:

$$f = 90 ° - \frac{v}{2} .$$

Angle g may be calculated as:

g=180°−90°−f, and

angle j may be calculated as:

j=180°−90°−a.

As:

$$sin ( g ) = \frac{e}{h} , \\ h = \frac{e}{sin ( g )} meters .$$

As:

$$sin ( j ) = \frac{c}{k} , \\ k = \frac{c}{sin ( j )} pixels .$$

As:

$$sin ( \frac{v}{2} ) = \frac{\frac{b}{2}}{m} , \\ m = \frac{\frac{b}{2}}{sin ( \frac{v}{2} )} pixels .$$

As:

$$tan ( a ) = \frac{n}{( \frac{b}{2} )} , \\ n = tan ( a ) \cdot \frac{b}{2} pixels .$$

While n might, in various embodiments, be taken to be indicative of the distance to be calculated, it is expressed in pixels rather than meters. However, as:

m=y+k pixels,

y=m−k pixels.

As y (expressed in pixels) corresponds to h (expressed in meters), a conversion value between meters and pixels of:

h/y meters per pixel may be calculated.

Then, distance z can be calculated in meters as:

$$z = n \cdot \frac{h}{y} .$$

As a numerical example corresponding to the foregoing, in the case of an aperture angle of 40°, a total image size of 144 pixels, a beneath-horizon image size value of 37 pixels, and a 1.7 meter distance between the aiming user's eyes and the ground, employing the above equations yields a distance of approximately 9.61 meters.

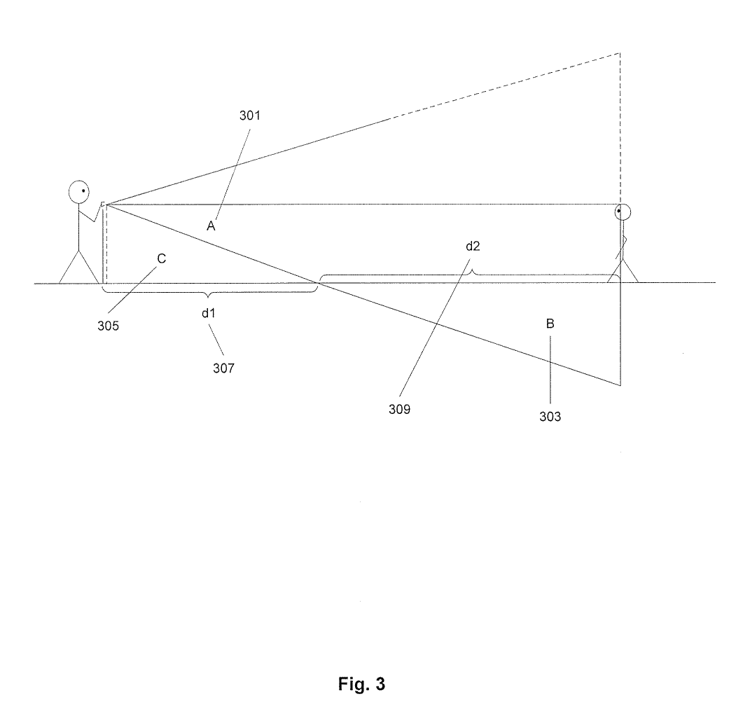

With respect to FIG. 3, a further exemplary distance calculation wherein the angle between an imaginary vertical line running the height of an aiming user and an imaginary line extending from the device of the aiming user (e.g., from a lens of the device) is 90° will now be discussed.

From, for instance, the point of view of performing calculations, taken to exist might be triangle A 301, triangle B 303, triangle C 305, distance d1 307, and distance d2 309. Taking h to be the height of the image plane, o_y to be the first y pixel where the targeted user appears on the image plane (e.g., with zero on the bottom), S_H to be the screen height in pixels, h_e to be the distance between the aiming user's eyes and the ground (e.g., calculated as discussed above), AV_V_n to be the vertical angle of view (e.g., the aperture angle) at a zoom level n, and D to be the distance between the aiming user and the targeted user, with respect to triangle A it might be noted that:

$$tan ( \frac{AV\_V \_n}{2} ) = \frac{\frac{h}{2}}{D} .$$

With respect to triangle B it might be noted that:

$$tan ( \frac{AV\_V \_n}{2} ) = \frac{o\_y}{S\_H \cdot h} .$$

With respect to triangle C it might be noted that:

$$tan ( \frac{AV\_V \_n}{2} ) = \frac{h\_e}{d 1} .$$

Then, distance D might be calculated as:

$$D = \frac{d 1}{( 1 - \frac{2 \cdot o\_y}{S\_H} )} .$$

It is noted that, in various embodiments, values taken into consideration in various operations might include one or more heights of one or more users, one or more heights of one or more users when standing, one or more heights of one or more users when sitting, one or more values for one or more users corresponding to distance between middle of eye and top of head, one or more user posture (e.g., sitting or standing) values for one or more users, one or more values for one or more users corresponding to user device offset from user eye height level, one or more horizontal angles of view (e.g., aperture angles) for one or more user devices, one or more user device lens distortion correction values (e.g., in terms of pixel x, y values), one or more screen widths (e.g., in terms of pixels), one or more values for one or more users corresponding to the middle x pixel where such a user appears on the image plane (e.g., with zero on the left side), one or more user device yaw angles (e.g., compass bearings), one or more user device pitch angles, and/or one or more user device roll angles.

Such yaw angles, pitch angles, and/or roll angles might, for instance, be current values. Such lens distortion values might, for instance, be employed as correction values in calculations. In various embodiments, vertical and/or horizontal angles of view might be known from user device hardware and/or software specifications, and/or might correspond to particular zoom levels.

As discussed above, an altitude of the second user might, for example, be obtained. The altitude of the second user might, in various embodiments, be employed in the case where the surface upon which first user is situated is not at the same level as the surface upon which the second user is situated. For example the first user might be situated at a higher level than the second user. As another example, the first user might be situated at a lower level than the second user.

The altitude of the second user might, for instance, be employed in a compensatory fashion in determination of the beneath-horizon image size value. For example, in the case where the second user is situated y meters higher than the first user, for purposes of determining the beneath-horizon image size value the portion of the image extending below the feet of the second user might be considered to start y meters lower than depicted in the image. As another example, in the case where the second user is situated z meters lower than the first user, for purpose of determining the beneath-horizon image size value the portion of the image extending below the feet of the second user might be considered to start z meters higher than depicted in the image.

Alternately or additionally, the altitude of the second user might, for instance, be employed to correct the second user's apparent height.

For example, in the case where the second user is situated upon a surface y meters higher than a surface upon which the first user is situated, one or more operations of the sort discussed above might adjust consideration of the second user's height in view of the notion that, due to the second user being situated y meters higher than the first user, the second user appears at the location of the first user (e.g., to a device of the first user) to bey meters taller than actual height.

As another example, in the case where the second user is situated upon a surface z meters lower than a surface upon which the first user is situated, one or more operations of the sort discussed above might adjust consideration of the second user's height in view of the notion that, due to the second user being situated z meters lower than the first user, the second user appears at the location of the first user (e.g., to a device of the first user) to be z meters shorter than actual height.

As discussed above, an indication of the body position of the second user (e.g., sitting or standing) and/or the height of the second user might, for example, be obtained. The height of the second user might, for instance, be employed in one or more calculations regarding the distance between the first user and the second user. For instance, the relation between the known height of the second user and the number of pixels depicting the second user's height might be employed in one or more calculations of the sort discussed above (e.g., in determination of a meters per pixel value).

In various embodiments, in the case where the body position of the second user is known, such might be taken into account. For instance, in the case where the second user is standing, the observed height of the second user might be taken to be the known height of the second user, while in the case where the second user is sitting the observed height of the second user might be taken to be less than the known height of the second user. For instance, the observed height might be taken to be the known height minus a certain offset, and/or the observed height might be taken to be a certain percentage of the known height. Such percentages and/or offsets might, for instance, be based on human physiology.

In various embodiments, the calculated distance between the first user and the second user might be updated. Such functionality might be implemented in a number of ways. For example, obtained might be information corresponding to a change in location by the second user's device. Such information might, for instance, be obtained and/or derived from output of orientation sensor hardware (e.g., one or more accelerometers and/or magnetometers). Perhaps in a manner analogous to that discussed above, such orientation sensor hardware might be included in and/or be in communication with the device of the second user. Such information might, for instance, indicate distance and/or direction.

In various embodiments, the case where a certain distance between the first user and the second user is calculated, and the obtained information provides a distance and/or direction indicating a change in location, an updated distance between the first user and the second user might, for instance, be calculated using the initial calculated value and the received distance and/or direction.

To illustrate by way of example, in the case where a distance of 9.6 meters between the first user and the second user is initially calculated, and received information indicates that the second device has moved such that it is three meters further away from the first user's device, the updated distance might be considered to be 12.6 meters. To further illustrate by way of example, in the case where a distance of 9.6 meters between the first user and the second user is initially calculated, and received information indicates that the second device has moved such that it is three meters closer to the first user's device, the updated distance might be considered to be 6.6 meters.

Although, so as to illustrate by way of example, functionality wherein distance between a first user and a second user has been discussed, according to various embodiments other functionality might, perhaps in a manner analogous to that discussed above, be implemented. For example, distance between a user and an area (e.g., including one or more objects), and/or between two areas might be calculated. As another example, distances among multiple areas and/or users might be calculated. For instance, distances between a user and two or more other users might be calculated. More generally, it is noted that, in various embodiments, distance might be calculated between a user and an entity, wherein the entity is, for example, an area, an object, a building, or a person. Such an entity might, for instance, be used as a reference point in a current and/or captured view.

In various embodiments, one or more bearings between one or more users and one or more areas (e.g., including one or more objects) might be calculated.

For example, taking b_m to be the bearing of the middle point of an image of such an area (e.g., obtained via compass hardware of a device of the aiming user), AV_H_n to be the horizontal angle of view (e.g., the aperture angle) at a zoom level n, S_W to be the screen width in pixels of the device of the aiming user, and o_x to correspond to the middle x pixel where the area appears on the image plane (e.g., with zero on the left side), bearing to the area b_o might be calculated as:

$$b\_o = b\_m - \frac{AV\_H \_n}{2} + ( \frac{o\_x}{S\_W} ) . AV\_H \_n .$$

Perhaps in a manner analogous to that discussed above, such compass hardware might, for instance, be included in and/or be in communication with a user device.

Various of the operations discussed herein might, for instance, be performed by a device of an aiming user, a device of a targeted user, and/or one or more other devices (e.g., one or more servers). Such performance might, for instance, involve communication among the device of the aiming user, the device of the targeted user, and/or the one or more other devices. Such communication might, for instance, be implemented in a manner analogous to that discussed above (e.g., SOAP, WiMAX, UMTS, and/or Bluetooth might be employed). For example, the device of the aiming user might receive from the device of the targeted user orientation sensor hardware output and/or altitude determination hardware output, and/or information derived therefrom.

Although, so as to illustrate by way of example, various operations have been discussed herein as being performed in terms of pixels (e.g., numbers of pixels), various operations discussed herein might, in various embodiments, be performed in terms of other than pixels. For instance, various operations discussed herein might be performed in terms of image capture area percentages.

Moreover, although, so as to illustrate by way of example, various operations have been discussed herein as being performed in term of meters, various operations discussed herein might, in various embodiments, be performed in terms of than meters. For instance, various operations discussed herein might be performed in terms of other units of metric measurement, and/or in terms of other measurement systems (e.g., in terms of Imperial units).

### View Operations

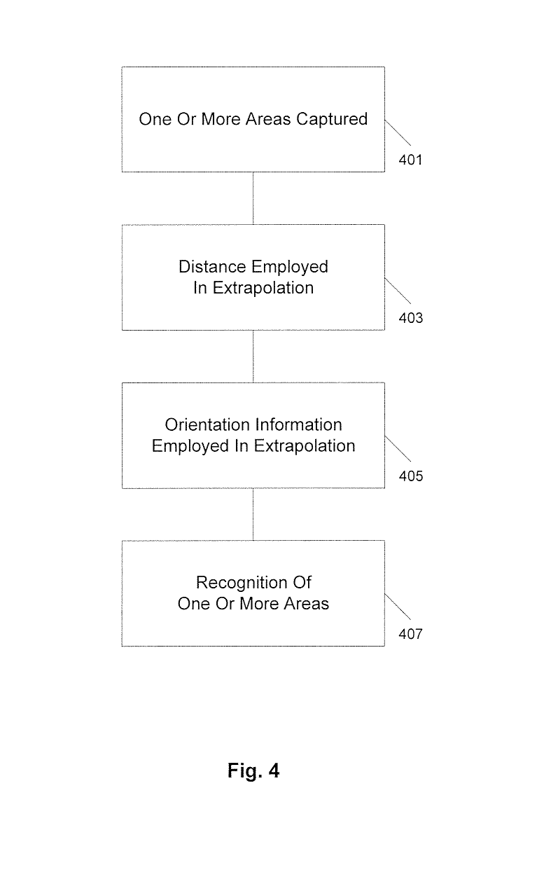

View functionality might, in various embodiments, be implemented. With respect to FIG. 4 it is noted that, for example, one or more areas (e.g., including one or more objects) captured by a device of a first user (step 401) might be recognized as captured by a device of a second user. Such areas might, for instance, be selected by a user (e.g., via a GUI and/or other interface) and/or by a device. Such functionality might be implemented in a number of ways.

For example, one or more operations might be performed so as to employ information in extrapolating, from the capture of an area by the first user's device, the area as captured by the device of the second user. Such information might, for instance, include distance between the first user's device and the second user's device, orientation information corresponding to the first user's device, and/or orientation information corresponding to the second user's device. Such distance might, for instance, be calculated as discussed above.

For instance, the distance might be employed in extrapolating the size of the area as captured by the device of the second user (step 403). For example, in the case where the distance between the first user's device and the second user's device indicates that the second user's device is, in comparison to the first user's device, further away from the area, image comparison functionality might be employed in searching one or more images captured by the device of the second user for an area looking like the area as captured by the device of the first user, but scaled to appear smaller to an extent consistent with the second user's device's greater distance from the area.

As another example, in the case where the distance between the first user's device and the second user's device indicates that the second user's device is, in comparison to the first user's device, closer to the area, image comparison functionality might be employed in searching one or more images captured by the device of the second user for an area looking like the area as captured by the device of the first user, but scaled to appear larger to an extent consistent with the second user's device's lesser distance from the area.

Alternately or additionally, the orientation information corresponding to the first user's device and/or orientation information corresponding to the second user's device might, for instance, be employed in extrapolating the placement of the area as captured by the device of the second user (step 405).

For example, in the case where the orientation information corresponding to one or both devices indicates that the second user's device is, in comparison to the first user's device, orientated further to the left, image comparison functionality might be employed in searching one or more images captured by the device of the second user for an area looking like the area as captured by the device of the first user, but shifted farther to the right to an extent consistent with the difference in orientation.

Alternately or additionally, in the case where the orientation information corresponding to one or both devices indicates that the second user's device is, in comparison to the first user's device, oriented further to the right, image comparison functionality might, for instance, be employed in searching one or more images captured by the device of the second user for an area looking like the area as captured by the device of the first user, but shifted farther to the left to an extent consistent with the difference in orientation.

Further alternately or additionally, in the case where the orientation information corresponding to one or both devices indicates that the second user's device is, in comparison to the first user's device, oriented further up, image comparison functionality might, for instance, be employed in searching one or more images captured by the device of the second user for an area looking like the area as captured by the device of the first user, but shifted farther down to an extent consistent with the difference in orientation.

Still further alternately or additionally, in the case where the orientation information corresponding to one or both devices indicates that the second user's device is, in comparison to the first user's device, oriented further down, image comparison functionality might, for instance, be employed in searching one or more images captured by the device of the second user for an area looking like the area as captured by the device of the first user, but shifted farther up to an extent consistent with the difference in orientation.

The extent to which scaling and/or shift is applied in extrapolating difference in apparent area size and/or placement due to difference in distance and/or orientation might, for instance, be determined using appropriate calculations (e.g., appropriate optical calculations) and/or using experimental data.

Via, for instance, one or more of the operations discussed above, one or more areas captured by the device of the first user might be recognized as captured by the device of the second user (step 407). One or more operations might, in various embodiments, be performed employing such recognition.

For example, in the case where a first user chooses (e.g., via a GUI and/or other interface) one or more areas captured by the first user's device, a second user may receive from the second user's device (e.g., via a GUI and/or other interface) indication of the one or more areas as captured by the second user's device. For instance, the one or more areas might be highlighted, shaded, and/or surrounded (e.g., by one or more rectangles and/or circles).

Provided for might, for example, be area manipulation. Such functionality might, for instance, be applicable in augmented reality, architecture, interior design, and/or gaming. For instance, a user might (e.g., via a GUI and/or other interface provided by her device) be able to place one or more virtual objects at one or more areas captured by her device, and/or be able to graphically alter one or more areas captured by her device (e.g., graphically manipulate one or more objects located at those one or more areas).

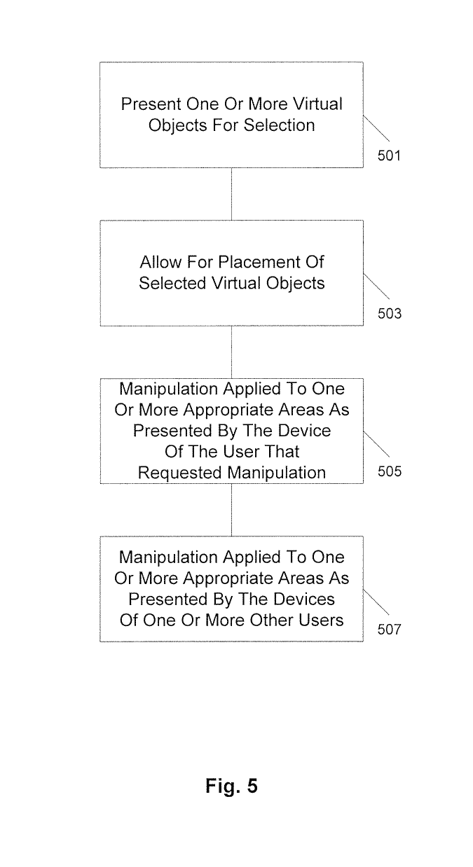

With respect to FIG. 5 it is noted that a user's device might (e.g., via a GUI and/or other interface), for example, present to the user one or more virtual objects for selection (step 501) and allow the user to place selected virtual objects at one or more areas captured by her device (e.g., via drag-and-drop functionality) (step 503).

Various sorts of virtual objects might, in various embodiments, be available. For example, furniture, architectural elements (e.g., doors, arches, columns, walls, and/or windows), and/or landscaping elements (e.g., trees and/or bushes) might be available. As further examples, vehicles and/or characters (e.g., people, animals, and/or fictional characters) might be available.

It is noted that, in various embodiments, placement of a virtual object might serve to replace a person or object at an area with the virtual object in terms of depiction by one or more devices. To illustrate by way of example, presented to a first user by her device might be depiction of a second user as captured by that device. Further, presented to a third user by her device might be a depiction of the second user as captured by that device. The first user might then act such that the depiction of the second user, as viewed at both devices, is replaced by a selected virtual object.

A user's device might (e.g., via a GUI and/or other interface), as another example, provide to the user one or more graphical alteration tools (e.g., pen tool, pencil tool, erasure tool, pattern tool, and/or fill tool) employable in graphical alteration.

The manipulation might, for instance, be applied to the one or more appropriate areas as presented by the device of the user that requested the manipulation (step 505), and/or applied to the one or more appropriate areas as presented by the devices of one or more other users (step 507).

In various embodiments, one or more of those other users might, in turn, be able to request area manipulation (e.g., in a manner analogous to that discussed above). Perhaps in a manner analogous to that discussed above, the manipulations might, for instance, be applied to one or more appropriate areas as presented by the one or more devices of those other users, and/or as presented by devices of one or more different users (e.g., the device of the user that initially requested manipulation and/or devices of one or more users that did not request manipulation).

To illustrate by way of example, manipulation of an area requested by a first user might be presented to the first user and to a second user, and a manipulation of that area or a different area requested by the second user might be presented to the second user and to the first user.

Manipulation functionality might, in various embodiments, be implemented in a manner employing functionality discussed above (e.g., recognition of the sort discussed above might be employed).

As another example, provided for might be provision of information regarding one or more areas. For instance, a user might (e.g., via a GUI and/or other interface provided by her device) be able to provide information (e.g., textual, graphical, audio, and/or video information) corresponding to one or more areas captured by her device.

The information might, for instance, be made available to the user that provided the information and/or to one or more other users. For instance, provided for each of one or more appropriate areas might be information corresponding to that area. Such information might (e.g., via a GUI and/or other interface) be superimposed over appropriate areas and/or be presented in response to user selection of one or more appropriate areas. Information functionality might, for in various embodiments, be implemented in a manner employing functionality discussed above (e.g., recognition of the sort discussed above might be employed).

To illustrate by way of example, such functionality might be employed for tours (e.g., city and/or museum tours). A tour guide user might, for instance, be able to employ her device to provide information regarding one or more items of interest, and tour participant users might be able to receive the information as discussed above.

As yet another example, provided for might be games involving one or more areas. For instance, a user might (e.g., via a GUI and/or other interface provided by her device) be able to associate one or more gaming results with one or more areas captured by her device. The device might, for instance, allow its user to select (e.g., via a GUI and/or other interface) from one or more pre-formulated games and/or to define one or more new games.

For example, functionality might be provided for a hunt game in which a first user might (e.g., via a GUI and/or other interface) be able to select one or more areas captured by her device as areas to be hunted, and one or more other users could employ their devices (e.g., via GUIs and/or other interfaces) to select among one or more areas as captured by their devices. Selection by such a user of an appropriate area might, for instance, result in points being awarded.

As another example, functionality might be provided for a pattern-following game in which a first user might (e.g., via a GUI and/or other interface provided by her device) be able to specify with respect to one or more areas captured by her device a selection order. The selection order might be presented to one or more other users (e.g., via GUIs and/or other interfaces provided by their devices) with respect to the one or more areas as captured by their devices. Following the presentation, each of the other users might be awarded points for selecting (e.g., via a GUI and/or other interface) the appropriate areas in the appropriate sequence.

To illustrate by way of example, captured by the device of a first user might be a tree, a rock, and a building. The user might (e.g., via a GUI and/or other interface) indicate the selection order “rock, rock, tree, rock.” This order might then be presented to one or more other users (e.g., via GUIs and/or other interfaces). For instance, the rock as captured by their devices might flash twice, then the tree as captured by their devices might flash, and then the rock as captured by their devise might again flash. Each of the one or more other users might be awarded points for selecting (e.g., via a GUI and/or other interface provided by her device) the rock and tree, as captured by her device, in the appropriate sequence.

Game functionality might, in various embodiments, be implemented in a manner employing functionality discussed above (e.g., recognition of the sort discussed above might be employed).

In various embodiments, the device of an aiming user might (e.g., as discussed above) get the distance and/or bearing to a targeted user. The device of the aiming user might, for instance, send to the device of the targeted user the distance and/or bearing. The aiming user might, for example (e.g., via a GUI and/or other interface), indicate one or more people and/or areas (e.g., including one or more objects) seen in a captured image. The heights of the selected people and/or areas might, for instance, be calculated based on numbers of vertical pixels in the captured image.

The device of the aiming user might, for example, send to the device of the targeted user the distances, bearings, and/or heights corresponding to the people and/or areas. The device of the targeted user might, for instance, employ its distance and/or bearing, the distances and/or bearings corresponding to the people and/or areas, and/or its current bearing (e.g., obtained from compass hardware of the device) in recognizing the people and/or areas as captured by the device of the targeted user. The device of the targeted user might, for example, indicate such people and/or areas to its user (e.g., via a GUI and/or other interface).

With respect to various of the operations discussed herein (e.g., regarding manipulation, information provision, and/or games) it is noted that, in various embodiments, user selection and/or user restriction options might be selectable. For example, a user performing area manipulation, providing information, and/or initiating one or more games might be able to select (e.g., via a GUI and/or other interface) the users that are allowed and/or not allowed to participate (e.g., see the manipulations, receive the information, and/or participate in the games).

Moreover, various of the operations discussed herein (e.g., regarding manipulation, information provision, and/or games) might, for instance, be performed by one or more user devices (e.g., by a device of an initiating user and/or by one or more other user devices), and/or by one or more other devices (e.g., one or more servers). Such performance might, for instance, involve communication among the devices in a manner analogous to that discussed above (e.g., SOAP, WiMAX, UMTS, and/or Bluetooth might be employed).

### Hardware and Software

Various operations and/or the like described herein may, in various embodiments, be executed by and/or with the help of computers. Further, for example, devices described herein may be and/or may incorporate computers. The phrases “computer,” “general purpose computer,” and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server, or the like, or any combination thereof, perhaps running an operating system such as OS X, Linux, Darwin, Windows CE, Windows XP, Windows Server 2003, Windows Vista, Palm OS, Symbian OS, or the like, perhaps employing the Series 40 Platform, Series 60 Platform, Series 80 Platform, and/or Series 90 Platform, and perhaps having support for Java and/or .Net.

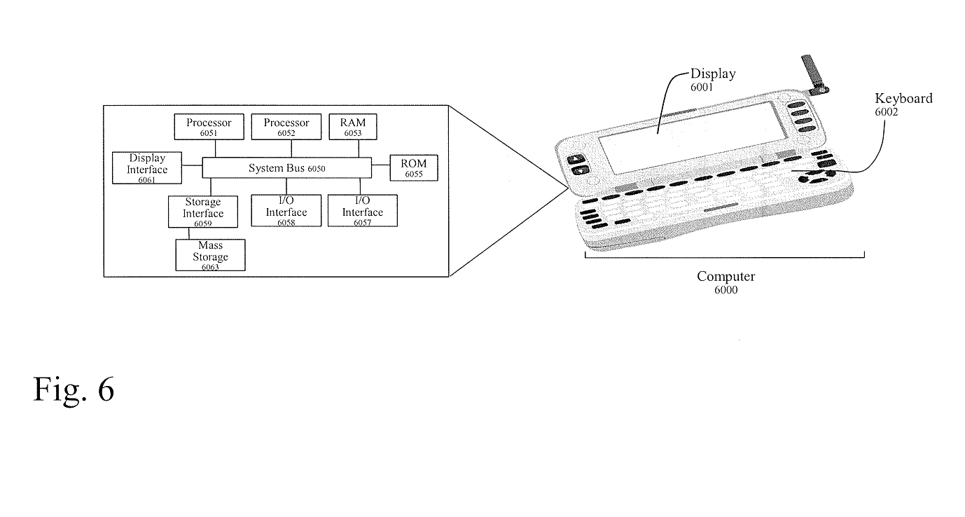

The phrases “general purpose computer,” “computer,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 6 is an exemplary computer employable in various embodiments of the present invention. Exemplary computer 6000 includes system bus 6050 which operatively connects two processors 6051 and 6052, random access memory 6053, read-only memory 6055, input output (I/O) interfaces 6057 and 6058, storage interface 6059, and display interface 6061. Storage interface 6059 in turn connects to mass storage 6063. Each of I/O interfaces 6057 and 6058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 6063 may be a hard drive, optical drive, a memory chip, or the like. Processors 6051 and 6052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, an Intel Core, or an IBM, Toshiba, or Sony Cell processor. Computer 6000 as shown in this example also includes a touch screen 6001 and a keyboard 6002. In various embodiments, a mouse, keypad, and/or interface might alternately or additionally be employed. Computer 6000 may additionally include or be attached to one or more image capture devices (e.g., employing Complementary Metal Oxide Semiconductor (CMOS) and/or Charge Coupled Device (CCD) hardware). Such image capture devices might, for instance, face towards and/or away from one or more users of computer 6000. Alternately or additionally, computer 6000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

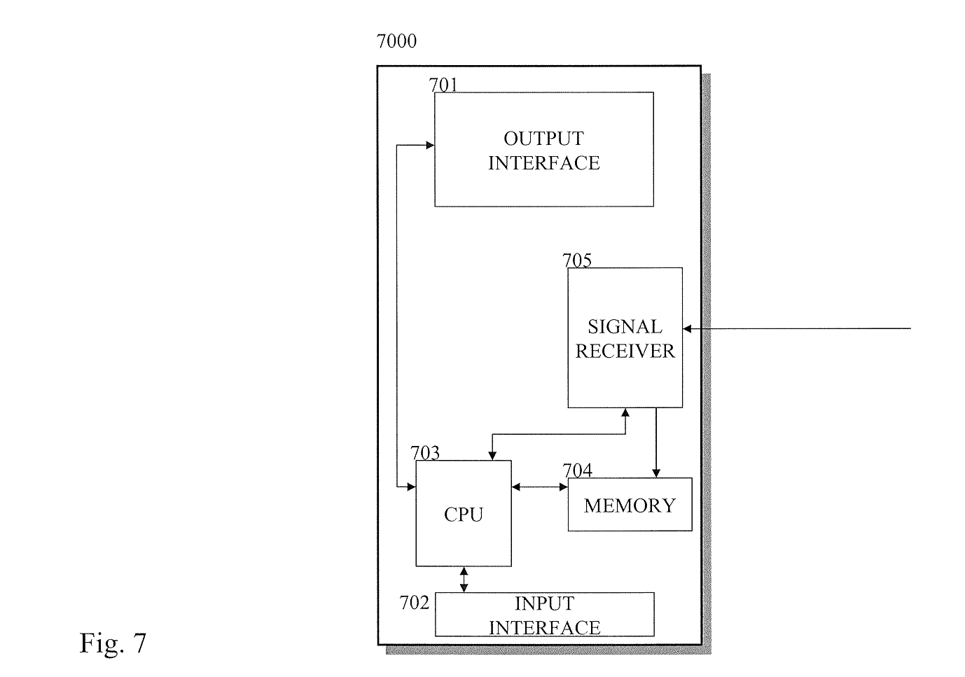

Shown in FIG. 7 is a block diagram of a terminal, an exemplary computer employable in various embodiments of the present invention. In the following, corresponding reference signs are applied to corresponding parts. Exemplary terminal 7000 of FIG. 7 comprises a processing unit CPU 703, a signal receiver 705, and a user interface (701, 702). Signal receiver 705 may, for example, be a single-carrier or multi-carrier receiver. Signal receiver 705 and the user interface (701, 702) are coupled with the processing unit CPU 703. One or more direct memory access (DMA) channels may exist between multi-carrier signal terminal part 705 and memory 704. The user interface (701, 702) comprises a display and a keyboard to enable a user to use the terminal 7000. In addition, the user interface (701, 702) comprises a microphone and a speaker for receiving and producing audio signals. The user interface (701, 702) may also comprise voice recognition (not shown).

The processing unit CPU 703 comprises a microprocessor (not shown), memory 704, and possibly software. The software can be stored in the memory 704. The microprocessor controls, on the basis of the software, the operation of the terminal 7000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 7, alternatively, middleware or software implementation can be applied. The terminal 7000 can, for instance, be a hand-held device which a user can comfortably carry. The terminal 7000 can, for example, be a cellular mobile phone which comprises the multi-carrier signal terminal part 705 for receiving multicast transmission streams. Therefore, the terminal 7000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

### Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
obtaining a height value corresponding to a user;
obtaining an optical value of a device of the user;
obtaining information corresponding to an orientation of the device;
obtaining an imaging value corresponding to capture of an entity by the device; and
calculating a distance between the user and the entity, wherein the height value, the optical value, the information corresponding to the orientation of the device, and the imaging value are employed in the calculation.

2. The method of claim 1, wherein the entity is a second user.

3. The method of claim 1, wherein the entity is an object.

4. The method of claim 1, further comprising obtaining an altitude value corresponding to the entity, wherein the altitude value is employed in the calculation.

5. The method of claim 2, further comprising obtaining a body position indication corresponding to the second user, wherein the body position indication is employed in the calculation.

6. The method of claim 1, further comprising obtaining a height value corresponding to the entity, wherein the height value corresponding to the entity is employed in the calculation.

7. The method of claim 2, further comprising:
obtaining orientation sensor output corresponding to the second user; and
updating the calculated distance, wherein the orientation sensor output is employed in the updating.

8. The method of claim 2, further comprising:
obtaining a displacement value corresponding to the second user; and
updating the calculated distance, wherein the displacement value is employed in the updating.

9. The method of claim 2, further comprising:
obtaining, from the user of the device, selection of an area, wherein the area is captured by the device,
wherein the area, as captured by a device of the second user, is recognized, and
wherein the distance and information corresponding to an orientation of the device of the second user are employed in the recognition.

10. The method of claim 2, further comprising:
obtaining, from the user of the device, manipulation corresponding to an area, wherein the area is captured by the device,
wherein the area, as displayed by a device of the second user, is altered in accordance with the manipulation.

11. A method, comprising:
obtaining a distance between a first user and a second user;
obtaining information corresponding to an orientation of a device of the first user;
obtaining information corresponding to an orientation of a device of the second user;
obtaining selection of an area, wherein the area is captured by the device of the first user; and
recognizing the area, as captured by the device of the second user, wherein the distance, the information corresponding to the orientation of the device of the first user, and the information corresponding to the orientation of the device of the second user are employed in the recognition.

12. The method of claim 11, further comprising:
obtaining, from the first user, manipulation corresponding to the area,
wherein the area, as displayed by the device of the second user, is altered in accordance with the manipulation.

13. The method of claim 12, wherein the manipulation comprises placement of a virtual object.

14. The method of claim 12, wherein the manipulation comprises graphical alteration of an object located at the area.

15. The method of claim 11, further comprising:
obtaining, from the second user, manipulation corresponding to the area,
wherein the area, as displayed by the device of the first user, is altered in accordance with the manipulation.

16. The method of claim 11, wherein the device of the second user is employed by the second user in hunting for the area, as displayed by the device of the second user.

17. The method of claim 11, wherein information regarding the area is obtained from the first user, and wherein the information regarding the area is presented to the second user in conjunction with display of the area.

18. The method of claim 11, wherein a user height value, an optical value, and information corresponding to an orientation are employed in calculating the distance.

19. An apparatus, comprising:
a memory having program code stored therein; and
a processor disposed in communication with the memory for carrying out instructions in accordance with the stored program code;
wherein the program code, when executed by the processor, causes the processor to perform:
obtaining a height value corresponding to a user;
obtaining an optical value of an apparatus of the user;
obtaining information corresponding to an orientation of the apparatus of the user;
obtaining an imaging value corresponding to capture of an entity by the apparatus of the user; and
calculating a distance between the user and the entity, wherein the height value, the optical value, the information corresponding to the orientation of the apparatus of the user, and the imaging value are employed in the calculation.

20. The apparatus of claim 19, wherein the entity is a second user.

21. The apparatus of claim 19, wherein the entity is an object.

22. The apparatus of claim 19, wherein the processor further performs obtaining an altitude value corresponding to the entity, wherein the altitude value is employed in the calculation.

23. The apparatus of claim 20, wherein the processor further performs obtaining a body position indication corresponding to the second user, wherein the body position indication is employed in the calculation.

24. The apparatus of claim 20, wherein the processor further performs:
obtaining orientation sensor output corresponding to the second user; and
updating the calculated distance, wherein the orientation sensor output is employed in the updating.

25. The apparatus of claim 20, wherein the processor further performs:
obtaining a displacement value corresponding to the second user; and
updating the calculated distance, wherein the displacement value is employed in the updating.

26. The apparatus of claim 20, wherein the processor further performs:
obtaining, from the user of the apparatus, selection of an area, wherein the area is captured by the apparatus of the user,
wherein the area, as captured by an apparatus of the second user, is recognized, and
wherein the distance and information corresponding to an orientation of the apparatus of the second user are employed in the recognition.

27. The apparatus of claim 20, wherein the processor further performs:
obtaining, from the user of the apparatus, manipulation corresponding to an area, wherein the area is captured by the apparatus of the user,
wherein the area, as displayed by an apparatus of the second user, is altered in accordance with the manipulation.

28. The apparatus of claim 19, further comprising:
a network interface disposed in communication with the processor,
wherein the apparatus is a wireless node.

29. An apparatus, comprising:
a memory having program code stored therein; and
a processor disposed in communication with the memory for carrying out instructions in accordance with the stored program code;
wherein the program code, when executed by the processor, causes the processor to perform:
obtaining a distance between a first user and a second user;
obtaining information corresponding to an orientation of an apparatus of the first user;
obtaining information corresponding to an orientation of an apparatus of the second user;
obtaining selection of an area, wherein the area is captured by the apparatus of the first user; and
recognizing the area, as captured by the apparatus of the second user, wherein the distance, the information corresponding to the orientation of the apparatus of the first user, and the information corresponding to the orientation of the apparatus of the second user are employed in the recognition.

30. The apparatus of claim 29, wherein the processor further performs:
obtaining, from the first user, manipulation corresponding to the area,
wherein the area, as displayed by the apparatus of the second user, is altered in accordance with the manipulation.

31. The apparatus of claim 30, wherein the manipulation comprises placement of a virtual object.

32. The apparatus of claim 30, wherein the manipulation comprises graphical alteration of an object located at the area.

33. The apparatus of claim 29, wherein the processor further performs:
obtaining, from the second user, manipulation corresponding to the area,
wherein the area, as displayed by the apparatus of the first user, is altered in accordance with the manipulation.

34. The apparatus of claim 29, wherein the apparatus of the second user is employed by the second user in hunting for the area, as displayed by the apparatus of the second user.

35. The apparatus of claim 29, wherein information regarding the area is obtained from the first user, and wherein the information regarding the area is presented to the second user in conjunction with display of the area.

36. The apparatus of claim 29, wherein a user height value, an optical value, and information corresponding to an orientation are employed in calculating the distance.

37. The apparatus of claim 29, further comprising:
a network interface disposed in communication with the processor,
wherein the apparatus is a wireless node.

38. An article of manufacture comprising a computer readable medium containing program code that when executed causes an apparatus to perform:
obtaining a height value corresponding to a user;
obtaining an optical value of an apparatus of the user;
obtaining information corresponding to an orientation of the apparatus of the user;
obtaining an imaging value corresponding to capture of an entity by the apparatus of the user; and
calculating a distance between the user and the entity, wherein the height value, the optical value, the information corresponding to the orientation of the apparatus of the user, and the imaging value are employed in the calculation.

39. An article of manufacture comprising a computer readable medium containing program code that when executed causes an apparatus to perform:
obtaining a distance between a first user and a second user;
obtaining information corresponding to an orientation of an apparatus of the first user;
obtaining information corresponding to an orientation of an apparatus of the second user;
obtaining selection of an area, wherein the area is captured by the apparatus of the first user; and
recognizing the area, as captured by the apparatus of the second user, wherein the distance, the information corresponding to the orientation of the apparatus of the first user, and the information corresponding to the orientation of the apparatus of the second user are employed in the recognition.
